(19) United States
(12) Patent Application Publication
(10) Pub. No.: US 2013/0038592 A1
(43) Pub. Date: Feb. 14, 2013

(54) Integrated Source Driver and Driving Method Thereof

(71) Applicant: Li-Tang Lin, Hsinchu City (TW)

(72) Inventor: Li-Tang Lin, Hsinchu City (TW)

(21) Appl. No.: 13/571,355

(22) Filed: Aug. 10, 2012

(30) Foreign Application Priority Data
Aug. 12, 2011 (TW) 100128865

(51) Int. Cl. G09G 5/00

(52) U.S. Cl. 345/211

(57) ABSTRACT

A driving method for a display device including one or more than one integrated source drivers includes generating at least a control signal, and transmitting the at least a control signal to a first integrated source driver of one or more than one integrated source drivers, so that the first integrated source driver generates at least a reference voltage according to the received control signal, wherein the at least a reference voltage is used for driving the first integrated source driver.

### BACKGROUND OF THE INVENTION

1. Field of the Invention

The present invention relates to a source driver and driving method thereof, and more particularly, to an integrated source driver and driving method thereof for saving cost.

2. Description of the Prior Art

Since high quality and low price of a liquid crystal display (LCD), LCD has been widely installed into information products, such as notebooks, personal digital assistant (PDA), mobile phone, and clock.

An LCD is mainly composed of single or multiple source drivers, single or multiple gate drivers and a panel. The source driver and the gate driver are used for controlling crossing data lines and scan lines in the panel, respectively. Each intersection of the data lines and the scan lines is connected to a thin film transistor, i.e. the thin film transistor is arranged with matrix on the panel, and each thin film transistor corresponds to a pixel. Noticeably, the traditional source driver is driven by inputting a specific reference voltage, so as to input data to the data line and drive the panel of the LCD. Since the reference voltage plays an important role for driving the panel, an extra amplifier is commonly used among many applications to enhance the driving ability of the reference voltage, and stabilize the voltage.

Please refer to FIG. 1, which is a schematic diagram of a conventional LCD having reference voltage amplifiers. For simplicity, a part of the source drivers and the reference voltages are shown in the diagram. A conventional method of generating the reference voltage is that the reference voltage amplifiers generate multiple reference voltages according to inputted control signals x and y, for providing the generated multiple reference voltages to each source driver, wherein 6 representative reference voltages are shown in FIG. 1. As shown in FIG. 1, with 6 reference voltages and 3 source drivers, a printed circuit board (PCB) of the LCD requires at least 6 traces to provide the reference voltages for each source driver, which means the number of the reference voltages determines the trace number of the PCB. As a result, the traditional method causes complexity of traces or routing in the LCD, limitation of PCB area, and thus LCD cost is high. However, the traces for the reference voltages are still necessary even without the reference voltage amplifiers to generate the reference voltage, e.g. voltage dividing via resistors. Therefore, problems of complicated traces and large PCB area are remained.

### SUMMARY OF THE INVENTION

It is therefore an object to provide an integrated source driver and driving method thereof capable of reducing trace number of a PCB of a display device, so as to save cost.

The present invention discloses a driving method, for a display device comprising one or more than one integrated source drivers, including generating at least a control signal, and transmitting the at least a control signal to a first integrated source driver of one or more than one integrated source drivers, so that the first integrated source driver generates a first number of reference voltages according to the received control signal, wherein the first number of reference voltages of the first integrated source driver is used for driving the first integrated source driver.

The present invention further discloses a first integrated source driver of a display device, including a receiving unit, for receiving at least a control signal, and a reference voltage generating unit, coupled to the receiving unit, for generating at least a reference voltage according to the at least a control signal, so as to drive the first integrated source driver.

The present invention further discloses a driving method, for a display device comprising a source driver, including generating a control signal, and transmitting the control signal to the source driver, so that the source driver generates at least a reference voltage according to the control signal, wherein the at least a reference voltage is used for driving the source driver.

The present invention further discloses a driving method, for a display device comprising a first integrated source driver and a second integrated source driver, including utilizing the first integrated source driver to generate a first number of reference voltages, and utilizing the second integrated source driver to generate a second number of reference voltages, wherein the first number of reference voltages and the second number of reference voltages are used for driving the first integrated source driver and the second integrated source driver.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional LCD having reference voltage amplifiers.

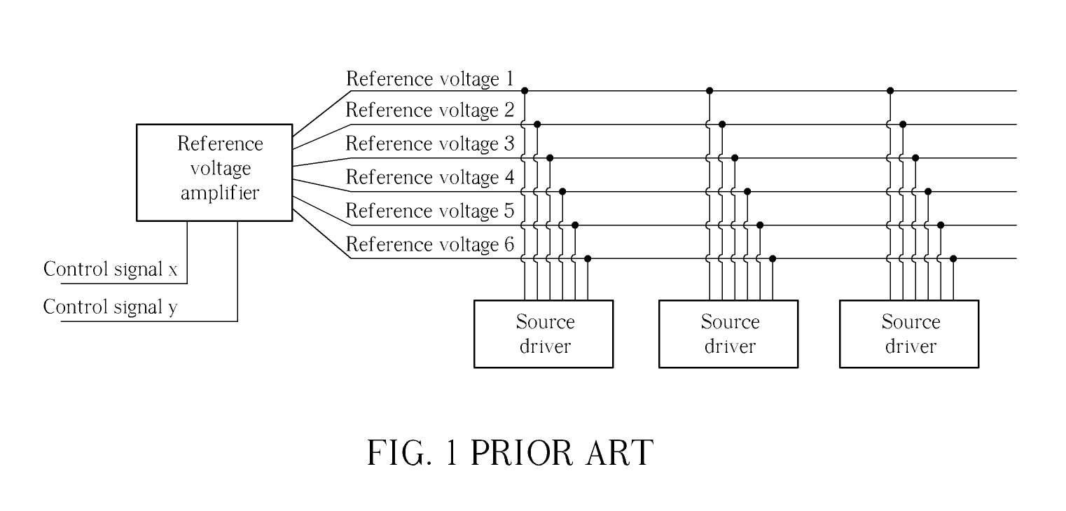

FIG. 2 is a schematic diagram of an integrated source driver according to an embodiment of the present invention.

FIG. 3 is a schematic diagram of a process according to an embodiment of the present invention.

FIG. 4 is a schematic diagram of the control signal transmission according to the first embodiment of the present invention.

FIG. 5 is a schematic diagram of an integrated source driver according to an embodiment of the present invention.

FIG. 6 is a schematic diagram of the control signal transmission according to a second embodiment of the present invention.

FIG. 7 is a relationship diagram between a conventional reference voltage and input data.

FIG. 8 is a relationship diagram between a reference voltage and input data.

### DETAILED DESCRIPTION

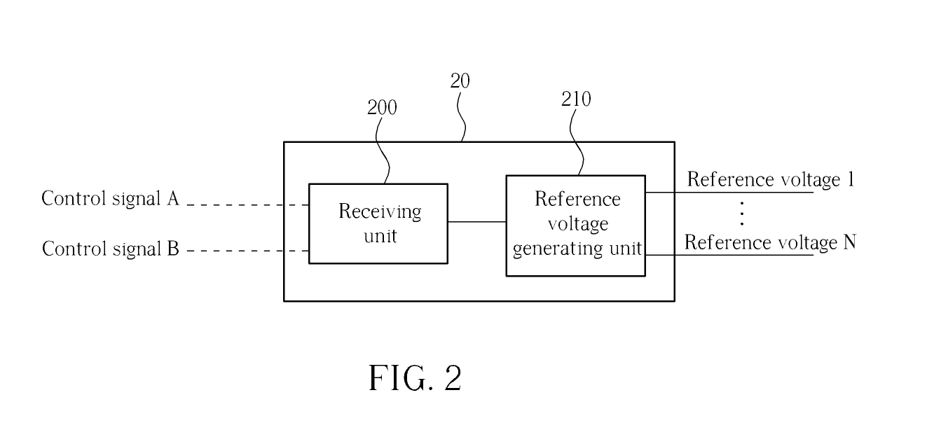

Please refer to FIG. 2, which is a schematic diagram of an integrated source driver 20 according to an embodiment of the present invention. The integrated source driver 20 includes a receiving unit 200 and a reference voltage generating unit 210. The receiving unit 200 is used for receiving at least a control signal, e.g. receiving from a timing controller not shown in the diagram. The reference voltage generating unit 210 is coupled to the receiving unit 200, for generating at least a reference voltage according to the at least a control signal, so as to drive the integrated source driver 20.

The integrated source driver 20 is driven if the receiving unit 200 and the reference voltage generating unit 210 are integrated to receive the at least a control signal, and generate the at least a reference voltage according to the at least a control signal, e.g. receiving from a timing controller not shown in the diagram.

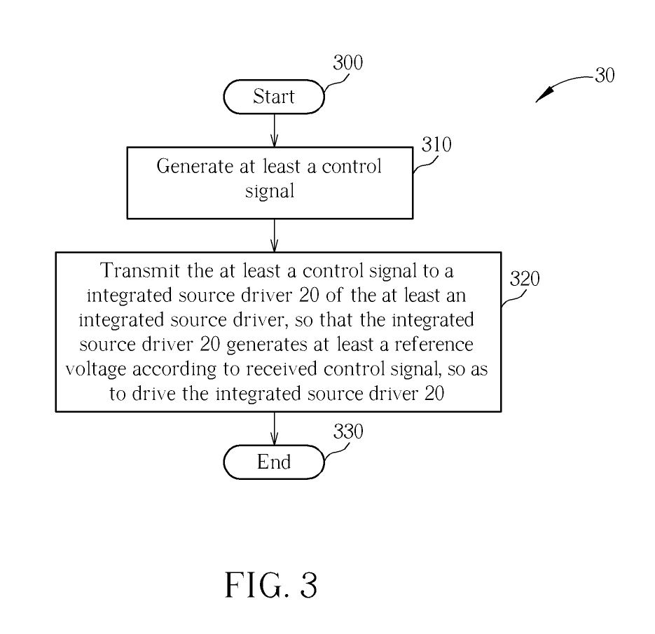

Please refer to FIG. 3, operations of the at least an integrated source driver 20 of the display device driving circuit can be summarized as a process 30. As shown in FIG. 3, the process 30 includes following steps:

Step 300: Start.

Step 310: Generate at least a control signal.

Step 320: Transmit the at least a control signal to a integrated source driver 20 of the at least an integrated source driver, so that the integrated source driver 20 generates at least a reference voltage according to received control signal, so as to drive the integrated source driver 20.

Step 330: End.

According to the process 30, the present invention is to transmit the control signals to the integrated source driver 20. After the receiving unit 200 of the integrated source driver 20 has received the control signal, the reference voltage generating unit 210 of the integrated source driver 20 generates the at least a reference voltage for the driving integrated source driver 20 according to the control signals received by the receiving unit 200. Since the reference voltage generating unit 210 of the integrated source driver 20 is capable of generating the self required reference voltages, extra traces for the reference voltage of the PCB is omitted, so that the trace number and routing are simplified and the PCB area is reduced, and thus saves cost.

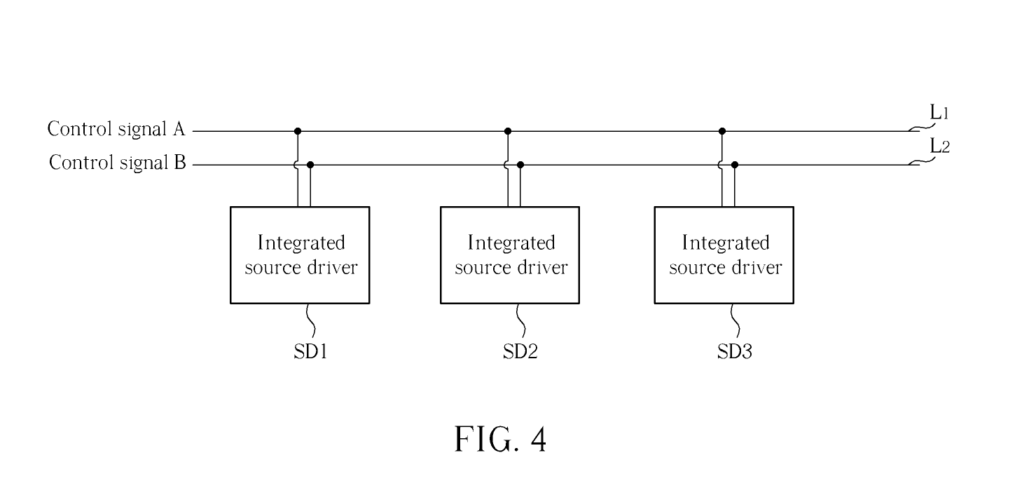

Based on the concept of the process 30, take the display device including one or more integrated source drivers 20 as an example. Please refer to FIG. 4, which is a schematic diagram of the control signal transmission according to the first embodiment of the present invention. For simplicity, there are 3 integrated source drivers shown in the FIG. 4. In FIG. 4, integrated source drivers SD1-SD3 receive control signals A and B through 2 control signal lines L1 and L2, respectively. Herein the control method of the present invention is also suitable for common data transmit interface, such as an inter-integrated circuit I2C bus (i.e. control signal line), an inter-IC sound (I2S) bus (i.e. four control signal lines) or system management bus (SMBus). Please refer to FIG. 2, and take the integrated source driver SD1 as an example. When the receiving unit of the integrated source driver SD1 has received the control signals A and B through the control signal lines L1 and L2, the reference voltage generating unit of the integrated source driver SD1 generates all of the reference voltages required for the integrated source driver SD1 according to the control signals A and B, so as to drive the integrated source driver SD1. Besides, all of the reference voltages generated by the integrated source driver SD1 may be further used for driving the integrated source drivers SD2 and SD3. The present invention is not limited via the integrated source driver SD1 to generate all of the reference voltages, while via any integrated source driver of the display device to generate all of the reference voltages is also suitable for driving the integrated source drivers SD1-SD3, e.g. via the integrated source driver SD2 to drive the integrated source drivers SD1-SD3.

In another embodiment, the integrated source driver SD1 generates a first number of the reference voltages for driving the integrated source driver SD1 rather than generates all of reference voltages. Besides, the integrated source drivers SD2 and SD3 may generate another reference voltages required for the integrated source driver SD1. For example, the integrated source driver SD2 and SD3 generate a second number and a third number of reference voltages, for driving the integrated source driver SD1, respectively. Noticeably, the first number to the third number of the reference voltages maybe same or different numbers of the reference voltages, and not limited to this.

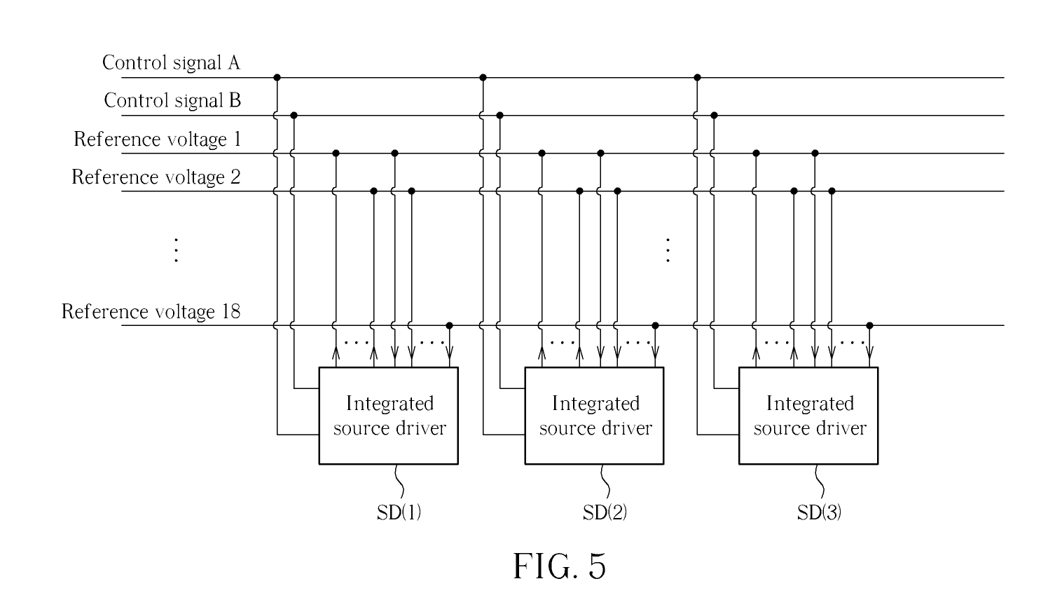

Furthermore, please refer to FIG. 5. After the integrated source drivers SD(1)-SD(3) have received the control signals A and B, the integrated source driver SD(1)-SD(3) generate and output a group of different reference voltages for other integrated source drivers, respectively, and thus the integrated source drivers SD(1)-SD(3) receive required reference voltages, respectively. For example, when the receiving unit of the integrated source driver SD(1)-SD(3) received the control signals A and B through the control signal lines L1 and L2, the reference voltage generating unit of the integrated source driver SD(1) generates the reference voltages 1-6 according to the control signals A and B; the integrated source driver SD(2) generates the reference voltage 7-12 according to the control signals A and B; the integrated source driver SD(3) generates the reference voltage 12-18 according to the control signal A and B. And then, the integrated source driver SD(1)-SD(3) output the generated reference voltage 1-6, 7-12, 12-18, so as to provide the reference voltages required for the integrated source driver SD(1)-SD(3), respectively. Noticeably, number of the integrated source driver and number of the reference voltages generated by each source driver are not limited to the embodiment shown in FIG. 5.

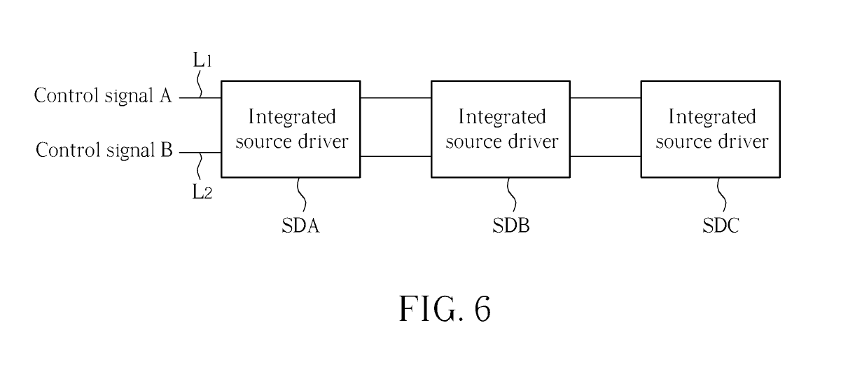

Besides, the way of transmitting the control signals A and B to the integrated source driver SD(1)-SD(3) is not only through the control signal lines L1 and L2 e.g. as shown in FIG. 4, but also through the integrated source drivers to transmit the control signals A and B. Please refer to FIG. 6, which is a schematic diagram of the control signal transmission according to a second embodiment of the present invention. In the second embodiment, one of the integrated source driver integrated source drivers SDA-SDC receives the control signals A and B through the control signal lines L1 and L2. Take the integrated source driver SDA as an example, the integrated source driver SDA receives the control signals A and B through the control signal lines L1 and L2, and the integrated source driver SDA transmits the received control signals A and B to the integrated source driver SDB accordingly. Likewise, the integrated source driver SDB transmits the received control signals A and B to the integrated source driver SDC, which saves traces of signal lines on the PCB. Operations of the integrated source drivers SDA-SDC generating the reference voltages can be obtained by referring above description, which is omitted herein.

In short, the reference voltage generating unit of the integrated source driver in the present invention itself generates the required reference voltages, which reduces number of traces and complexity of routing for the reference voltages on the PCB. In other words, only the control signal lines are arranged on the PCB, such as I2C, I2S or SMBus, such that the integrated source driver generates the required reference voltages according to the received control signals, so as to drive the integrated source driver, which simplifies the trace routing on the PCB significantly, and reduces the PCB area, and thus saves cost. Moreover, the present invention further saves the usage of the reference voltage amplifiers, which saves manufacturing cost for the display device.

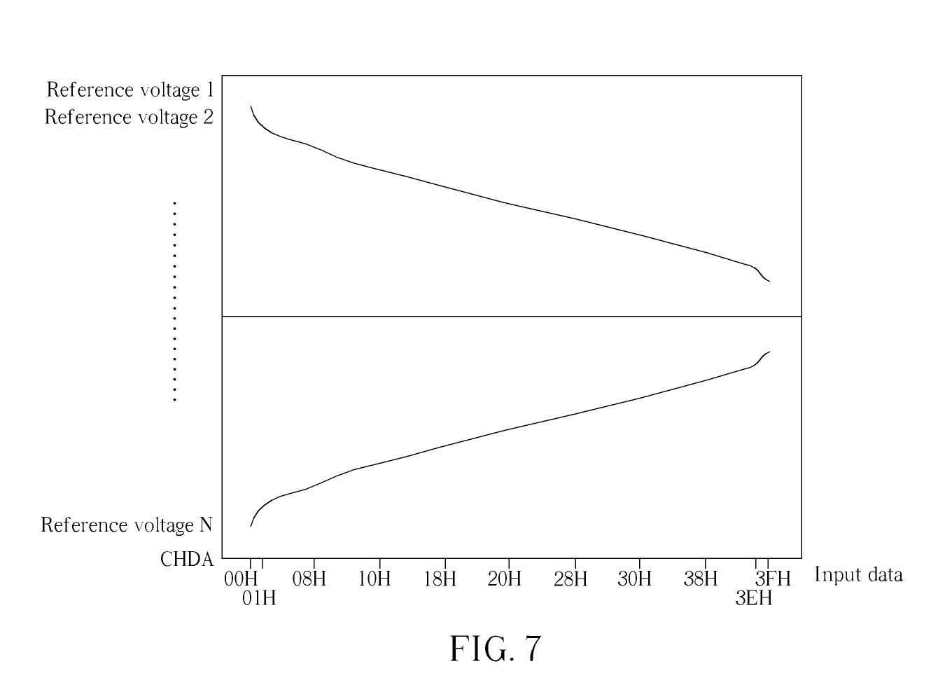

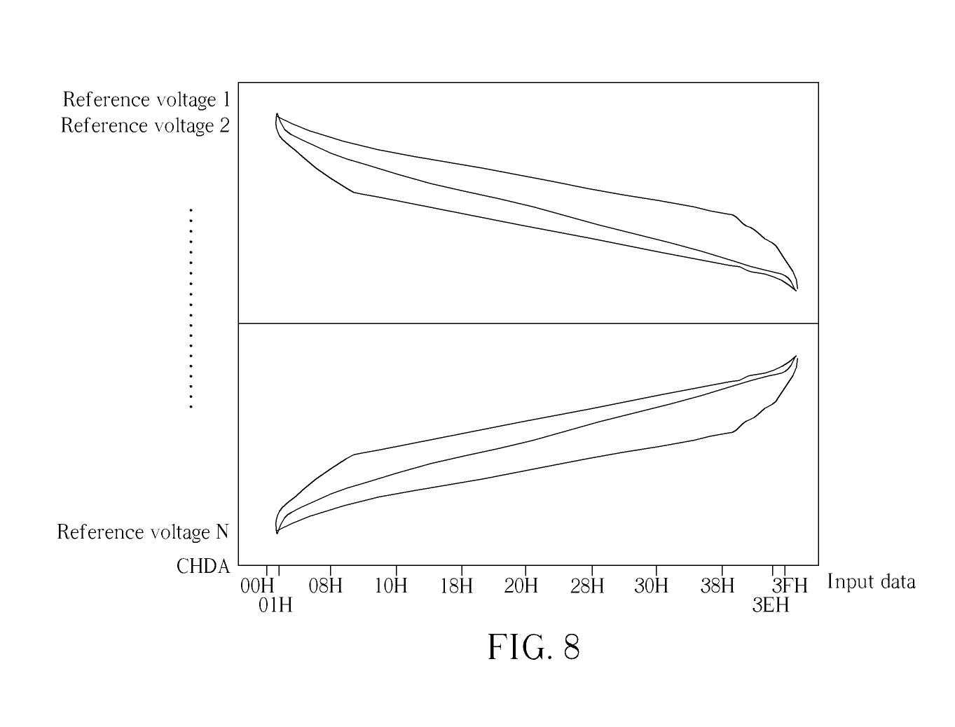

Besides, the present invention dynamically adjusts the reference voltages generated by the integrated source driver, so as to meet requirements for different applications, e.g. power saving. Please refer to FIG. 7, which is a relationship diagram between a conventional reference voltage and input data. Since the conventional reference voltages 1-N are generated through the reference voltage amplifiers, the conventional source driver receives the identical reference voltage 1-N as shown in FIG. 7, and thus a curve that outputted by the source driver to the data line corresponding to the reference voltage is fixed, wherein the input data is inputted to the data line for controlling the panel of the display device. Oppositely, the reference voltage of the present invention is generated through the integrated source driver, so that the integrated source driver generates different reference voltages shown in FIG. 8. For example, input different control signals to each integrated source driver to dynamically adjust the reference voltages, or utilize different reference voltage generating units in each integrated source driver, and thus the input data generated by different integrated source drivers corresponding to the reference voltages may have multiple curve variations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method, for a display device comprising one or more than one integrated source drivers, the driving method comprising:
generating at least a control signal; and
transmitting the at least a control signal to a first integrated source driver of one or more than one integrated source drivers, so that the first integrated source driver generates a first number of reference voltages according to the received control signal;
wherein the first number of reference voltages of the first integrated source driver is used for driving the first integrated source driver.

2. The driving method of claim 1, further comprising:
transmitting the at least a control signal to a second integrated source driver of the one or more than one integrated source drivers, so that the second integrated source driver generates a second number of reference voltages according to the received control signal;
wherein the second number of reference voltages are used for driving the first integrated source driver.

3. The driving method of claim 2, wherein the step of transmitting the at least a control signal to a second integrated source driver comprises:
transmitting the at least a control signal to the second integrated source driver via at least a control signal line; or
transmitting the at least a control signal to the second integrated source driver via the first integrated source driver.

4. The driving method of claim 1, wherein the first number of reference voltages are further used for driving the one or more than one integrated source drivers except for the first integrated source driver.

5. A first integrated source driver of a display device, comprising:
a receiving unit, for receiving at least a control signal; and
a reference voltage generating unit, coupled to the receiving unit, for generating at least a reference voltage according to the at least a control signal, so as to drive the first integrated source driver.

6. The source driver of claim 5, wherein the at least a reference voltage generated by the reference voltage generating unit is further used for driving a second integrated source driver of the one or more than one integrated source drivers of the display device.

7. The source driver of claim 5, wherein the receiving unit receives the at least a control signal via at least a control signal line, and the at least a control signal line is an inter-integrated circuit (I2C) bus, an inter-IC sound (I2S) bus or a system management bus (SMBus).

8. A driving method, for a display device comprising a source driver, comprising:
generating a control signal; and
transmitting the control signal to the source driver, so that the source driver generates at least a reference voltage according to the control signal;
wherein the at least a reference voltage is used for driving the source driver.

9. A driving method for a display device comprising a first integrated source driver and a second integrated source driver, the driving method comprising:
utilizing the first integrated source driver to generate a first number of reference voltages; and
utilizing the second integrated source driver to generate a second number of reference voltages;
wherein the first number of reference voltages and the second number of reference voltages are used for driving the first integrated source driver and the second integrated source driver.
